(19) United States
(12) Patent Application Publication
(10) Pub. No.: US 2006/0157319 A1
(43) Pub. Date: Jul. 20, 2006

(54) Inter-conveyed postal matter gap correction apparatus and postal matter processing apparatus equipped with the same

(75) Inventor: Masanori Sato, Kanagawa-ken (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/334,535

(22) Filed: Jan. 19, 2006

(30) Foreign Application Priority Data
Jan. 19, 2005 (JP) JP 2005-011043

(51) Int. Cl. B65G 47/31

(52) U.S. Cl. 198/460.1; 209/586

(57) ABSTRACT

An inter-conveyed postal matter gap correction apparatus includes a postal matter supply means, a detecting means for detecting the thickness or weight of the postal matter supplied from the postal matter supply means, a gap measuring sensor for measuring a gap between the postal matter supplied from the postal matter supply means, a variable speed driving means arranged on the downstream side of the detecting means and the gap measuring sensor for driving the postal matter supplied from the postal matter supply means at various speeds, a memory for storing a correction value for driving the postal matter at various speeds by the variable speed driving means on the basis of the thickness or weight of the postal matter detected by the detecting means, a preceding gap which is a gap between the present postal matter to be corrected which is measured by the gap measuring sensor and the just prior preceding postal matter, and a succeeding gap which is a gap between the present postal matter to be corrected and the just after succeeding postal matter, and a setting means for setting a drive speed of the variable speed driving means using the correction value stored in the memory.

### CROSS-REFERENCE TO RELATED APPLICATIONS

This application is based upon and claims the benefit of priority from the prior Japanese Patent Application JP2005-11043 filed on Jan. 19, 2005, the entire content of which is incorporated herein by reference.

### FIELD OF THE INVENTION

The present invention relates to a postal matter processing apparatus for sorting postal matter assigned with address information according to the address information and more particularly to an inter-conveyed postal matter gap correction apparatus for correcting an inter-conveyed postal matter gap of the postal matter to be conveyed and a postal matter processing apparatus equipped with the inter-conveyed postal matter gap correction apparatus.

### BACKGROUND OF THE INVENTION

In a conventional postal matter processing apparatus for sorting postal matter, thick or heavy postal matter bumps against a conveying roller, thus a lowering in the conveying speed appears remarkably. This slowdown causes a short gap during conveyance and causes jam due to the gate operation and bumping against gate during stacking or chaining jam due to unstable stacking.

Therefore, a method for keeping the conveying speed of postal matter to be conveyed constant and keeping the gap between conveyed postal matter unchanged and a method for measuring the conveying speed between two points when the gap is changed and correcting the conveying speed have been proposed (see Japanese Patent Application 2001-261194, pages 1 to 3 and FIG. 8).

Further, a method for reducing variations in conveyance for thickness of postal matter is known (see Japanese Patent Application 11-314803, page 2 and FIG. 2).

However, the method described in Japanese Patent Application 2001-261194 does not perform an operation of classifying postal matter depending on the thickness or weight thereof, thereby correcting the conveying speed, so that a problem arises that the conveying path is long and while postal matter is conveyed in contact with a plurality of conveying rollers, the gap between conveyed postal matter is changed gradually.

Furthermore, the method described in Japanese Patent Application 11-314803 detects the thickness of postal matter to be conveyed by a thickness detection roller, sets a gap of a pair of correction rollers by an arm connected to the thickness detection roller, thereby conveys the postal matter, so that it does not perform an operation of classifying postal matter depending on the weight thereof, thereby correcting the conveying speed, so that a problem arises that the conveying path is long and while postal matter is conveyed in contact with a plurality of conveying rollers, the gap between conveyed postal matter is disordered gradually.

### SUMMARY OF THE INVENTION

The present invention was developed to solve the aforementioned problems and provides an inter-conveyed postal matter gap correction apparatus and a postal matter processing apparatus for classifying postal matter by the thickness and the weight thereof or at least one of them and a difference in the gap between conveyed postal matter at two separated places on the conveying path and on the basis of this classifying, a gap (hereinafter referred to as a preceding gap) between the present postal matter to be corrected and the just prior preceding postal matter, and a gap (hereinafter referred to as a succeeding gap) between the present postal matter to be corrected and the just after succeeding postal matter, driving the postal matter to be corrected at variable speeds, thereby correcting a gap between postal matter.

To accomplish the above object, the inter-conveyed postal matter gap correction apparatus of the first embodiment of the present invention is equipped with a postal matter supply means for supplying postal matter, a conveying means for conveying postal matter supplied from the postal matter supply means, a thickness detecting means for detecting the thickness of the postal matter conveyed by the conveying means, a gap measuring sensor for measuring a gap between the postal matter conveyed by the conveying means, a variable speed driving means arranged on the downstream side of the thickness detecting means and the gap measuring sensor for increasing or decreasing the conveying speed of the postal matter, a memory for storing a correction value for increasing or decreasing the conveying speed of the postal matter by the variable speed driving means on the basis of the thickness of the postal matter detected by the thickness detecting means, a preceding gap which is a gap between the present postal matter to be corrected which is measured by the gap measuring sensor and the just prior preceding postal matter, and a succeeding gap which is a gap between the present postal matter to be corrected and the just after succeeding postal matter, and a setting means for setting a drive speed of the variable speed driving means using the correction value stored in the memory.

Further, the inter-conveyed postal matter gap correction apparatus of the second embodiment of the present invention is equipped with a postal matter supply means for supplying postal matter, a conveying means for conveying postal matter supplied from the postal matter supply means, a weight detecting means for detecting the weight of the postal matter conveyed by the conveying means, gap measuring sensor for measuring a gap between the postal matter conveyed by the conveying means, a variable speed driving means arranged on the downstream side of the weight detecting means and the gap measuring sensor for increasing or decreasing the conveying speed of the postal matter, a memory for storing a correction value for increasing or decreasing the conveying speed of the postal matter by the variable speed driving means on the basis of the weight of the postal matter detected by the weight detecting means, a preceding gap which is a gap between the present postal matter to be corrected which is measured by the gap measuring sensor and the just prior preceding postal matter, and a succeeding gap which is a gap between the present postal matter to be corrected and the just after succeeding postal matter, and a setting means for setting a drive speed of the variable speed driving means using the correction value stored in the memory.

Additional objects and advantages of the present invention will be apparent to persons skilled in the art from a study of the following description and the accompanying drawings, which are hereby incorporated in and constitute a part of this specification.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIGS. 1A and 1B are external views of a postal matter processing apparatus 100 equipped with the gap correction apparatus of the present invention.

FIG. 2 is a block diagram showing a controller 30 for controlling the postal matter processing apparatus.

FIG. 3 is a schematic block diagram showing a gap correction apparatus 11 between postal matter using a thickness detecting means.

FIGS. 4A to 4D are drawings showing a shift information area and a gap table, which are stored in a memory 37a, for correcting a gap between conveyed postal matter on the basis of the aforementioned thickness classifying detected respectively.

FIG. 5 is a flow chart showing the flow of a gap correction process based on the thickness classifying of postal matter.

FIGS. 6A to 6C are drawings showing an example when the gap correction process based on the thickness classifying of postal matter is performed on the basis of the flow chart shown in FIG. 5.

FIG. 7 is a schematic block diagram of the gap correction apparatus 11 using a weight detecting means.

FIGS. 8A and 8B are drawings for explaining the operation of a postal matter weight detection apparatus 50.

FIGS. 9A to 9D are drawings showing the shift information area and the gap table, which are stored in the memory 37a, for correcting a gap on the basis of the weight class of postal matter.

FIG. 10 is a flow chart showing the flow of the gap correction process based on the weight class of postal matter.

FIGS. 11A to 11C are drawings showing the shift information area and the gap table, which are stored in the memory 37a, for correcting a gap on the basis of gap information between conveyed postal matter at two separated places on the conveying path.

FIG. 12 is a flow chart showing the flow of the gap correction process based on the gaps between conveyed postal matter at the two separated places aforementioned.

FIGS. 13A to 13D are drawings showing an example when the gap correction process based on the gaps between conveyed postal matter at the two separated places on the conveying path is performed on the basis of the flow chart shown in FIG. 10.

### DESCRIPTION OF THE PREFERRED EMBODIMENTS

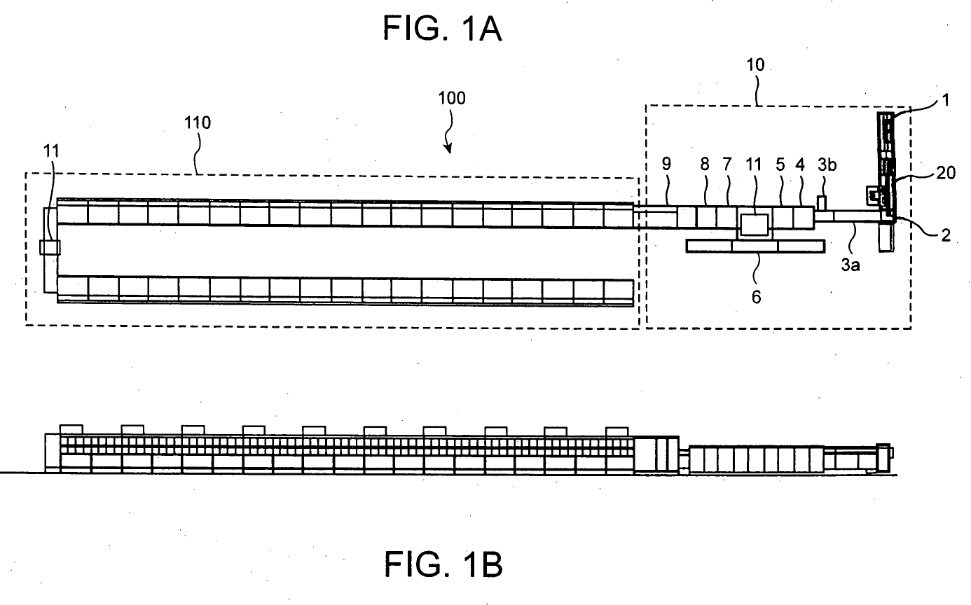

The present invention will be described in detail with reference to the FIGS. 1A through 13D.

### Embodiment 1

FIGS. 1A and 1B are a plan view and a front view showing the postal matter processing apparatus 100 equipped with a first gap correction apparatus 11a of the present invention. The postal matter processing apparatus 100 is equipped with a postal matter supply-reading apparatus 10.

The supply-reading apparatus 10 takes out postal matter one by one from a supply portion 1 thereof and reads destination information recorded on the sheet. Furthermore, the postal matter processing apparatus 100 is equipped with a stacker 110 for sorting the postal matter on the basis of the destination information read by the supply-reading apparatus 10.

Further, for postal matter which cannot be read by the supply-reading apparatus 10, the destination information recorded part thereof is recorded on video tape. The image information is transmitted to a video coding system (hereinafter referred to as a VCS) and on the basis of the image information displayed on a monitor, the destination information is input separately by an operator. The destination information input separately is converted to a bar code in a specific format during online processing and is printed on the concerned postal matter by an ink jet printer 7.

The supply-reading apparatus 10 is equipped with a supply portion 1, a take-out portion 2, an ejection stacker 3b, a pre-bar code reading portion 4, a character reading 5, a VCS processing-conveying path 6, an ink jet printer 7, a verify bar code reading portion 8, a branching portion 9, a gap correction apparatus 11, and an operating panel 20.

In the postal matter processing apparatus 100, postal matter is set in the supply portion 1, and a start switch (not drawn) of the operating panel 20 is turned on to start the processing apparatus, thus the postal matter is taken out from the take-out portion 2.

An error detection portion 3a detects an error take-out condition of postal matter, non-postal matter mixed in taken out postal matter, and a foreign substance such as nonstandard-size postal matter and ejects it to the ejection stacker 3b. The error take-out condition of postal matter includes, for example, a condition that a plurality of postal matter overlaid thick are taken out and a condition that two or more postal matter overlaid gapless or partially are taken out. When the former error take-out condition is detected, the supply-reading apparatus can detect postal matter with a thickness larger than a specified value and remove them once. When the latter error take-out condition is detected, the supply-reading apparatus can detect postal matter with a length in the conveying direction longer than a specified value and remove them once. Postal matter passing through the error detection portion 3a is conveyed to the pre-bar code reading portion 4 and the character reading portion 5.

The pre-bar code reading portion 4 and the character reading portion 5 read the destination information such as the bar code, zip code, and address which are recorded on the postal matter.

The VCS processing-conveying path 6 is a conveying path provided to move once postal matter, whose destination information cannot be read by the character reading portion 5, from the regular line to here and input separately the destination information by an operator using the VCS.

The ink jet printer 7 converts destination information, which is set on the basis of information subject to the VCS process by the pre-bar code reading portion 4 and the character reading portion 5 or VCS processing-conveying path 6, to a bar code in a specific format and prints it. The aforementioned bar code printed by the ink jet printer 7 is checked again by the verify bar code reading portion 8. Thereafter, the controller 30, which will be described later, decides finally the destination stacker for each postal matter. A gate (not drawn) of the branching portion 9 is operated so as to sort the postal matter to the concerned stacker on the basis of this final decision result. The postal matter sorted by the branching portion 9 is conveyed to the stacker 110 and is stacked on the destination stacker decided finally by the controller 30.

The gap correction apparatus 11, since the gap between conveyed postal matter is closed or opened due to the attributes of the postal matter itself, for example, mainly the weight or thickness thereof, corrects the gap between conveyed postal matter to a predetermined gap. The gap correction apparatus 11, in this embodiment, is arranged on the upstream side of the VCS processing-conveying path 6 and on the stacker 110. Further, the arrangement position of the gap correction apparatus 11 is not limited to the aforementioned places and can be changed properly according to the constitution and the scale of the postal matter processing apparatus.

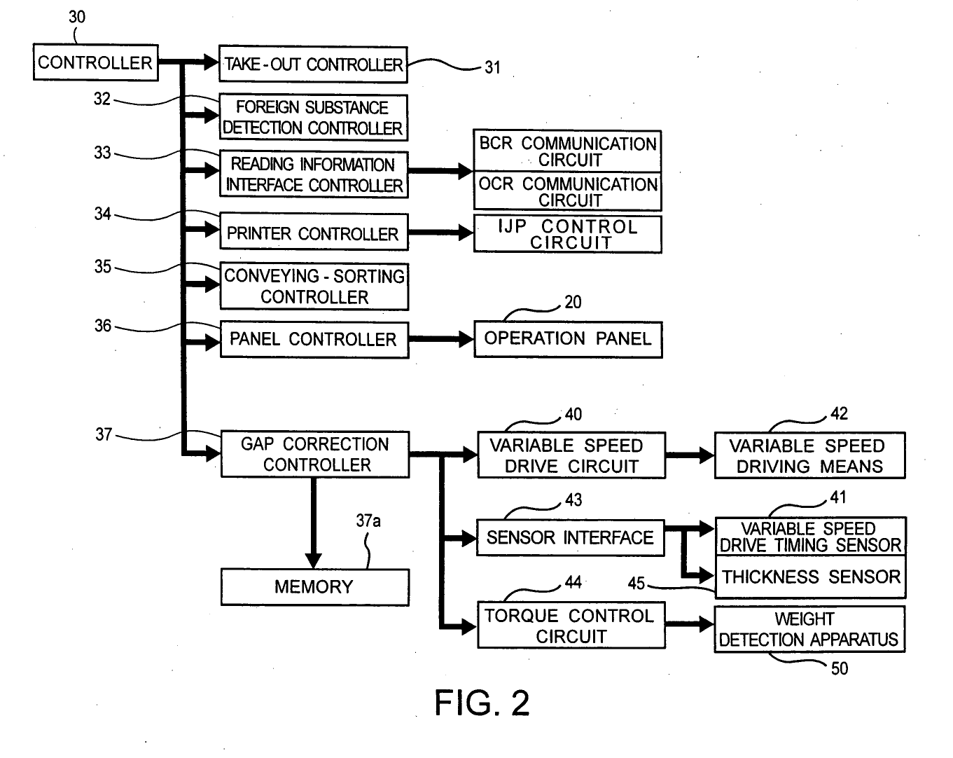

FIG. 2 is a block diagram showing the controller 30 for controlling the postal matter processing apparatus 100. The controller 30 controls a take-out controller 31 for controlling the take-out portion 2, a foreign substance detection controller 32 for controlling the error detection portion 3a, a reading information interface controller 33 for transferring destination information of postal matter, a printer controller 34 for controlling the ink jet printer 7 for printing a bar code converted from the destination information on postal matter, a conveying-sorting controller 35 for sorting postal matter and stacking it on the destination stacker decided finally, a panel controller 36 for displaying the postal matter stacking condition on the stacker and the error generation information of the apparatus on the operation panel 20, and a gap correction controller 37 for keeping the gap between conveyed postal matter constant.

The gap correction controller 37 has a CPU not drawn and the memory 37a and controls a variable speed drive control circuit 40 for controlling a variable speed driving means 42, a sensor interface 43 for inputting detection output from a variable speed drive timing sensor 41 and detection output from a thickness sensor 45, and a torque control circuit 44 for controlling a postal matter weight detection apparatus 50. The memory 37a stores a correction value which will be described later.

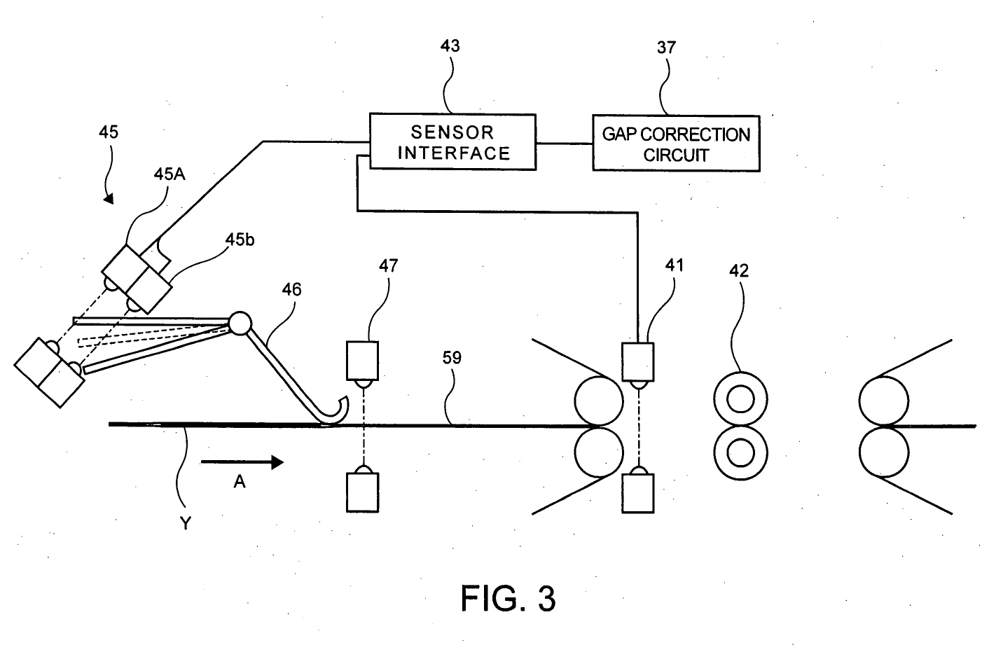

FIG. 3 is a schematic block diagram showing the gap correction apparatus 11 between postal matter using the thickness detecting means. The gap correction apparatus 11 is equipped with, sequentially from the upstream side in the postal matter conveying direction, thickness sensors 45a and 45b, a thickness detection guide 46, a gap measuring sensor 47 for measuring the gap between conveyed postal matter, the variable speed driving means 42, and the variable speed drive timing sensor 41 for timing the operation of the variable speed driving means 42.

The thickness sensors 45a and 45b are an optical sensor composed of a projector and a receptor arranged close to each other. When one end of the detection guide 46 is pushed up by postal matter moving in the direction of the arrow A and is rotated according to the thickness of the postal matter, the optical sensor detects the rotation condition of the other end of the thickness detection guide 46. The thickness of postal matter, according to a combination of output of the thickness sensors 45a and 45b, is classified as shown in the following Equations (1) to (3) by a classifying means included in the controller 30 or the gap correction controller 37. Further, “0” represents a dark condition that the thickness detection guide 46 is not rotated by the postal matter and the thickness sensor is blocked by the other end aforementioned and “1” represents a bright condition that the thickness detection guide 46 is rotated by the postal matter and the thickness sensor is not blocked by the other end aforementioned.

| | Thickness | Thickness | |
|---|---|---|---|
| | Sensor 45b | Sensor 45a | |
| (1) | 0 | 0 | 0 mm < postal matter thickness ≦ |
| | | | 2 mm |
| (2) | 0 | 1 | 2 mm < postal matter thickness ≦ |
| | | | 4 mm |
| (3) | 1 | 1 | 4 mm < postal matter thickness ≦ |
| | | | 6 mm |

The variable speed driving means 42, when the gap between conveyed postal matter measured by the gap measuring sensor 47 is deviated from the set value, corrects the deviated amount.

The variable speed drive timing sensor 41 times the operation of the variable speed driving means 42 and a drive speed of the variable speed driving means is set at the timing detected by the variable speed drive timing sensor 41.

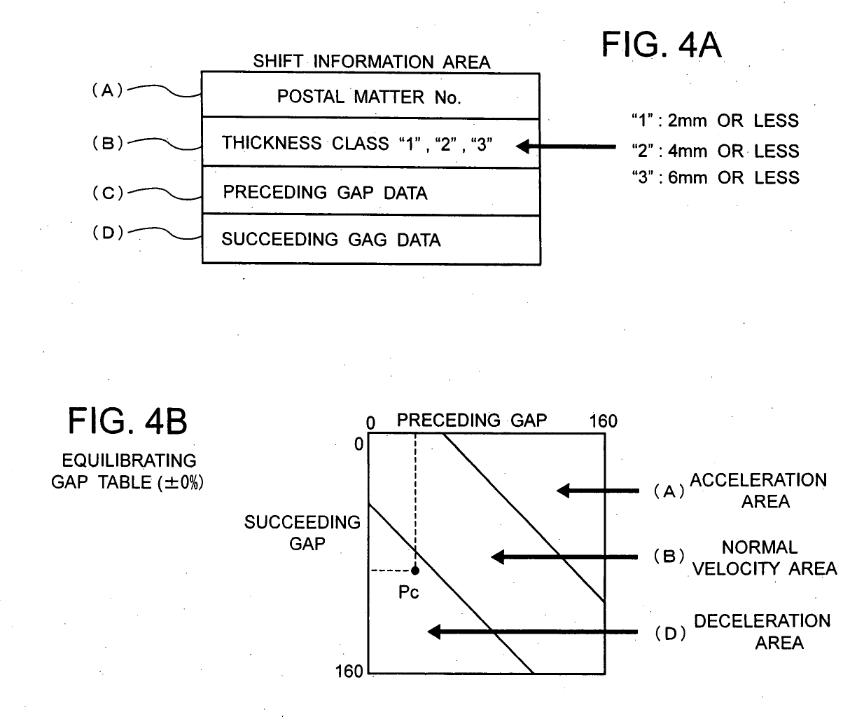

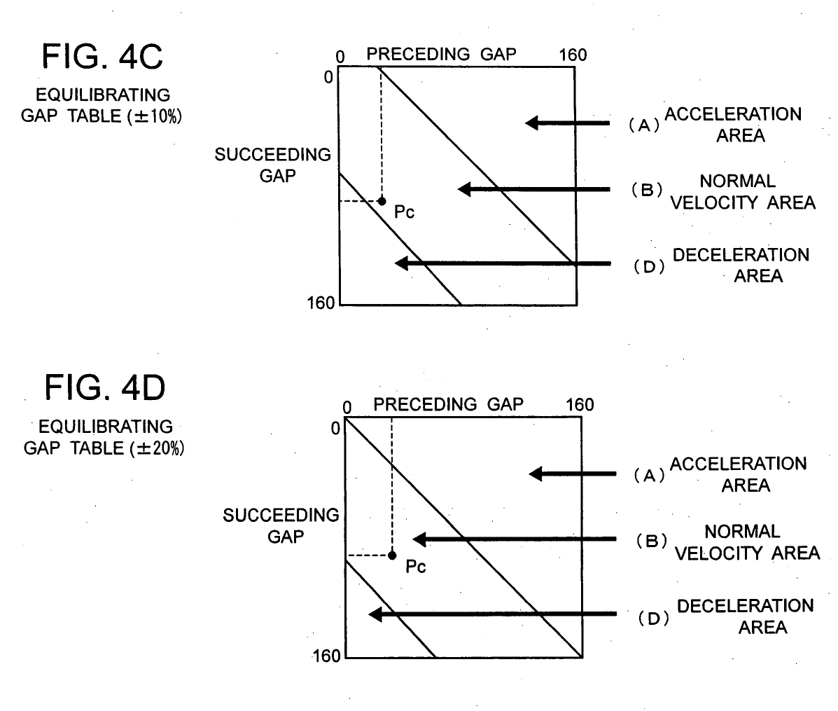

FIGS. 4A to 4D are drawings showing a shift information area and a gap table, which are stored in the memory 37a, for correcting a gap between conveyed postal matter on the basis of the aforementioned thickness classifying detected respectively. The gap table is a table of a correction value for correcting the gap between conveyed postal matter and is stored in the memory 37a. Hereinafter, a setting means for setting a drive speed of the variable speed driving means 42 will be explained by using a correction value stored in the memory 37a. Further, in the variable speed driving means 42, a correction value is set by a CPU (not drawn) of the gap correction controller 37.

FIG. 4A shows a shift information area assigned for each postal matter to sort the postal matter to be conveyed. In FIG. 4A, an area A shows a zip code equivalent to the ID of postal matter. In FIG. 4A, an area B shows thickness classifying of postal matter and on the basis of the thickness of postal matter which is detected by the thickness sensor, thickness class “1”, thickness class “2”, and thickness class “3” are set as shown by the following Equations (4) to (6).
“1”: 0 mm<postal matter thickness≦2 mm (4)
“2”: 2 mm<postal matter thickness≦4 mm (5)
“3”: 4 mm<postal matter thickness≦6 mm (6)

In FIG. 4A, an area C shows the data of the gap between the present postal matter to be corrected which is measured by the gap measuring sensor 47 and the just prior preceding postal matter, that is, the preceding gap. In FIG. 4A, an area D shows the data of the gap between the present postal matter to be corrected which is measured by the gap measuring sensor 47 and the just after succeeding postal matter, that is, the succeeding gap.

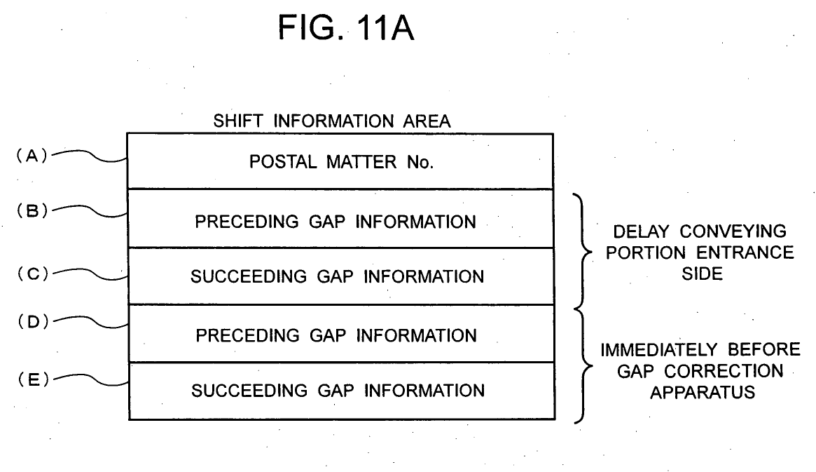

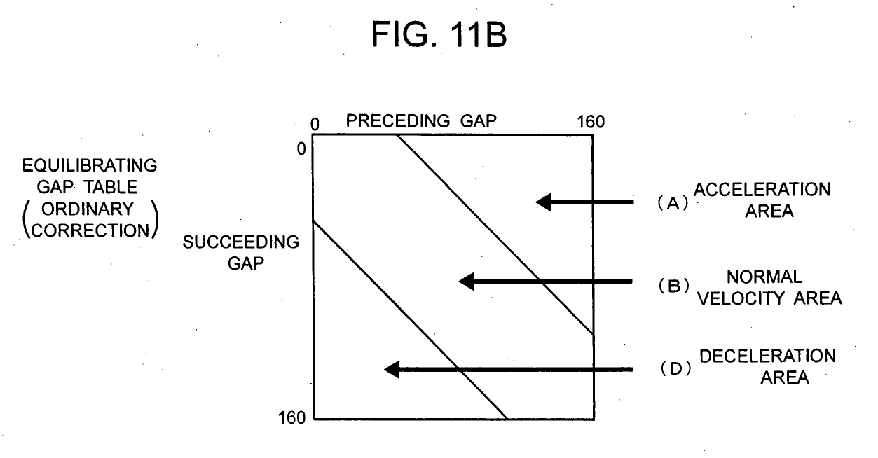

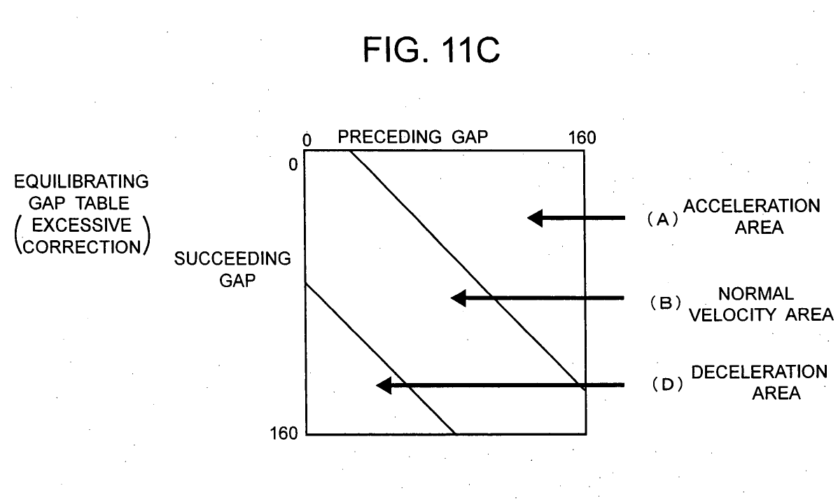

FIGS. 11B to 11D show the gap tables. From the gap tables, on the basis of the thickness class (“1”, “2”, and “3” represented above) of postal matter which is set in the shift information area, one gap table is selected from the gap table selecting means included in the controller 30. Further, using the preceding gap information and the succeeding gap information as an index, a correction value is selected by a correction value selecting means included in the controller 30. The drive speed of the variable speed driving means 42 is set by the data selected by the correction value selecting means.

For example, in FIG. 4B, an intersection point Pc of the preceding gap data and the succeeding gap data, since the succeeding gap is large and the preceding gap is small, exists consequently in the deceleration area (C). It is equivalent to a case that the conveyance proceeds. In this case, it is necessary to decelerate the concerned postal matter so as to balance the preceding gap data and the succeeding gap data. The acceleration area (A) and the normal velocity area (B) are set similarly.

FIG. 4B shows the gap table when the thickness class is “1” (0 mm≦postal matter thickness≦2 mm). In this case, thin postal matter is an object to be adjusted, so that for the data set in the preceding gap and the succeeding gap, the drive speed of the variable speed driving means 42 is not corrected according to the thickness of postal matter. Therefore, an equilibrating gap table (±0%) is used.

FIG. 4C shows the gap table when the thickness class is “2” (2 mm<postal matter thickness≦4 mm). In this case, thick postal matter is an object to be adjusted, so that for the data set in the preceding gap and the succeeding gap, the drive speed of the variable speed driving means 42 is corrected by ±10% according to the thickness of postal matter. Therefore, in this case, an equilibrating gap table (±10%) is used. As a result, the intersection point Pc aforementioned is included in the normal velocity area (B) of the equilibrating gap table. As mentioned above, when postal matter is thick, even if the postal matter moves forward, supposing that it is delayed gradually during the subsequent conveyance, the normal velocity area (B) is sued.

FIG. 4D shows the gap table when the thickness class is “3” (4 mm<postal matter thickness≦6 mm). In this case, thicker postal matter is an object to be adjusted, so that for the data set in the preceding gap and the succeeding gap, the drive speed of the variable speed driving means 42 is corrected by ±20% according to the thickness of postal matter. Therefore, in this case, an equilibrating gap table (±20%) is used. As a result, also in this case, the intersection point Pc aforementioned is included in the normal velocity area (B) of the equilibrating gap table.

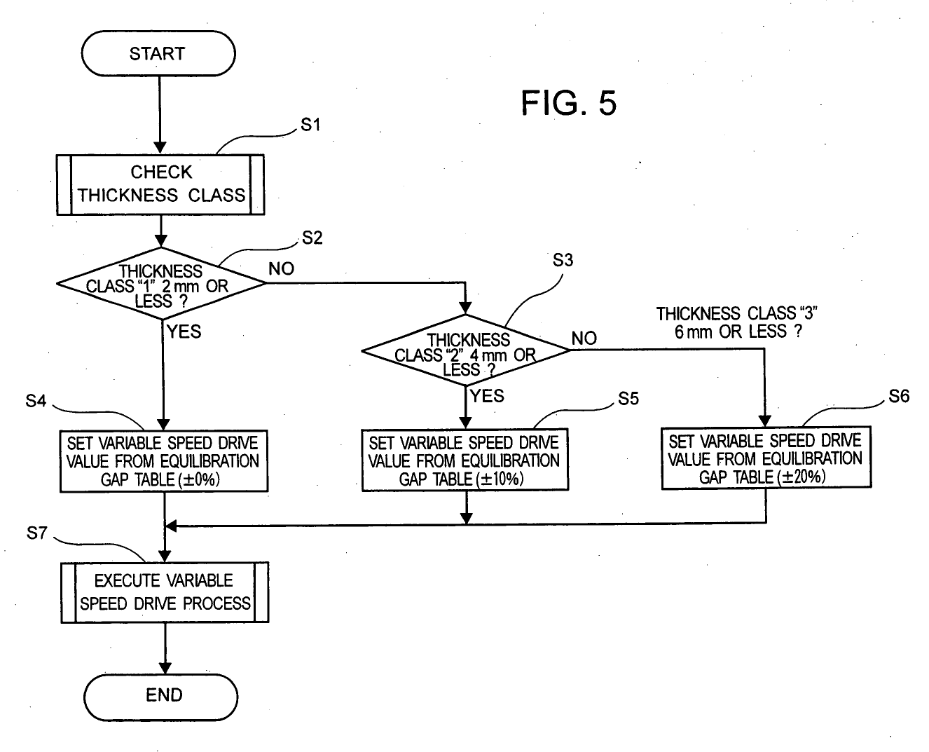

FIG. 5 is a flow chart showing the flow of the gap correction process based on the thickness class of postal matter. Firstly, the thickness class of postal matter is checked (Step S1).

As a result of the thickness class check, when the thickness of postal matter is up 2 mm (branch of yes at Step S2), the process goes to Step S4 and sets one drive speed from the equilibrating gap table (±0%) information.

As a result of the thickness class check, when the thickness of postal matter is above 2 mm up to 4 mm (branch of yes at Step S3), the process goes to Step S5 and sets one drive speed from the equilibrating gap table (±10%) information.

As a result of the thickness class check, when the thickness of postal matter is above 4 mm up to 6 mm (branch of no at Step S3), the process goes to Step S6 and sets one drive speed from the equilibrating gap table (±20%) information.

On the basis of one drive speed selected from the equilibrating gap table (Steps S4 to S6), the gap correction process is executed. By doing this, a gap correction operation added with the conveyance delay caused by the thickness of postal matter can be realized.

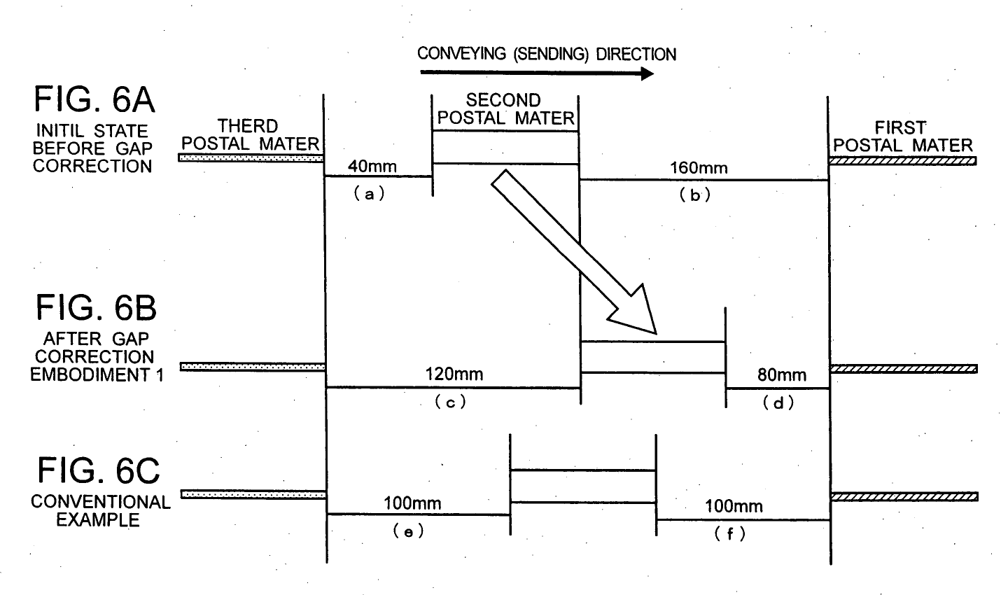

FIGS. 6A to 6C show an example when the gap correction process based on the thickness class of postal matter is performed on the basis of the flow chart shown in FIG. 5. FIG. 6A shows the initial state before gap correction. Here, a condition that sequentially from the top, for the first and the third postal matter with a thickness of 2 mm and the second postal matter with a thickness of 6 mm, the second postal matter is driven at various speeds by the variable speed driving means 42, and the gap with the preceding and the succeeding postal matters, that is, the first and the third postal matter is adjusted will be explained by referring to FIG. 6B.

FIG. 6B shows a condition of postal matter after the acceleration operation in this embodiment after the gap correction, and FIG. 6C shows a condition of postal matter after the acceleration operation by the conventional method after the gap correction, and for easy understanding, the conditions are shown against each other.

The thickness of the second postal matter is 6 mm, so that the equilibrating gap table (±20%) is selected from the shift information area. From the table, a drive speed of the succeeding gap (a) of 40 mm and the preceding gap (b) of 160 mm is taken out. And, from a relationship of succeeding gap (a)<preceding gap (b), the acceleration process is selected.

In the conventional gap correction process, the gap correction process is executed so as to set the gaps (e) and (f) between conveyed postal matter to the value given in the following Equation (7).
(e)=(f)=((a)+(b))/2 (7)

As a result, after the gap correction, the succeeding gap (e) becomes 100 mm and the preceding gap (f) becomes 100 mm.

On the other hand, in the gap correction process in this embodiment, since the equilibrating gap table (±20%) is selected, the gap correction process is executed so as to set the gap (c) between conveyed postal matter to the value given in the following Equation (8).
(c)=1.2×((a)+(b))/2 (8)

In this embodiment, in consideration of thickness class, the succeeding gap (c) is set to 1.2×((a)+(b))/2. As a result, the succeeding gap (c) is corrected to 120 mm and the preceding gap (d) is corrected to 80 mm. Immediately after the gap correction, the preceding gap and the succeeding gap are not equal. However, thick postal matter is apt to be delayed during conveyance, so that in the neighborhood of stacking, the preceding gap and the succeeding gap become equal.

### Embodiment 2

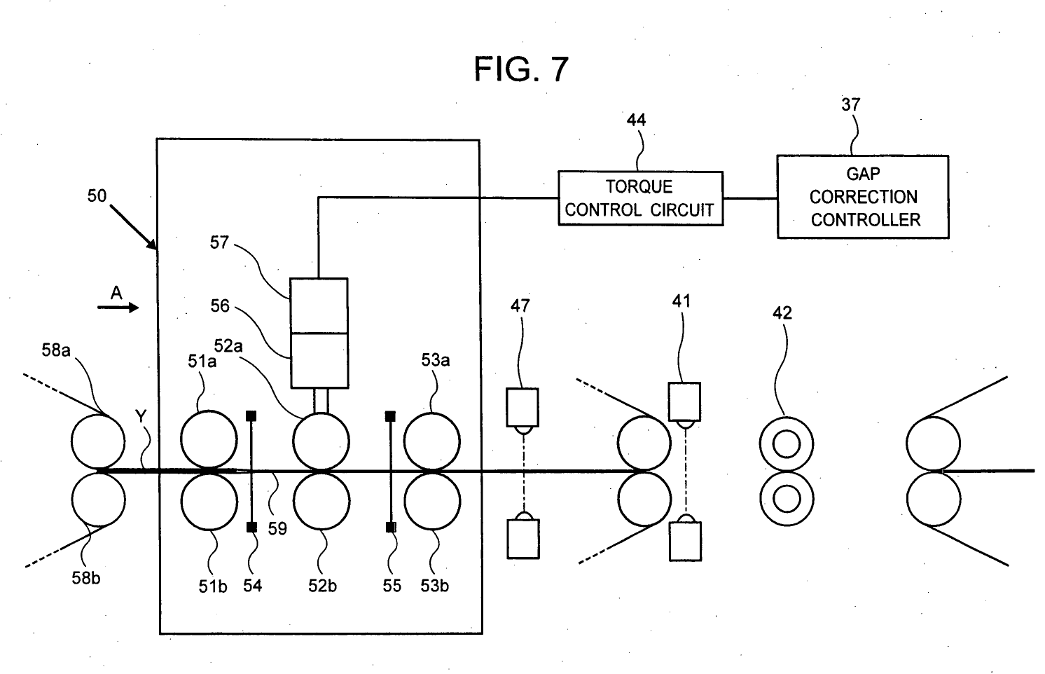

FIG. 7 is a schematic block diagram of the gap correction apparatus 11 using a weight detecting means. Therefore, the gap correction apparatus 11 is equipped with, from the upstream side in the conveying direction, the weight detection apparatus 50, the gap measuring sensor 47 for measuring the gap between conveyed postal matter, the variable speed driving means 42, and the variable speed drive timing sensor 41 for timing the operation of the variable speed driving means 42.

Here, the same parts as those in Embodiment 1 are assigned the same numerals, and the explanation thereof is omitted, and only the weight detection apparatus 50 will be explained.

The aforementioned weight detection portion (weight detecting means) 50 has a pinch roller 51b, on the upstream side in the conveying direction, arranged in the opposite position of a conveying roller 51a via a drive roller 51a and a conveying path 59. Postal matter Y is taken in by the drive roller 51a and the pinch roller 51b and the conveying speed of the postal matter Y taken in is decreased. Further, a position sensor 54 for detecting the position of the postal matter Y in the conveying path is arranged on the downstream side of the drive roller 51a in the conveying direction.

Further, in the weight detection portion 50, a drive roller 52a for detecting the conveying torque of the decelerated postal matter Y, a pinch roller 52b arranged in the opposite position of a conveying roller 4a via the conveying path 59 of the drive roller 52a, a servo motor 56 for setting a rotational speed of the drive roller 52a and driving the drive roller 52a, a rotary encoder 57 for measuring the rotational speed of the servo motor 56, and a torque control circuit 44 for calculating weight from the torque outputted from the servo motor 56 are arranged. Furthermore, another position sensor 55 is arranged on the downstream side of the drive roller 52a in the conveying direction.

Furthermore, the weight detection portion 50 includes a drive roller 53a for returning the conveying speed of the postal matter Y decelerated by the drive roller 52a and the pinch roller 52b to the conveying speed before deceleration and a pinch roller 53b arranged in the opposite position of a conveying roller 5a via the conveying path 59 of the drive roller 53a.

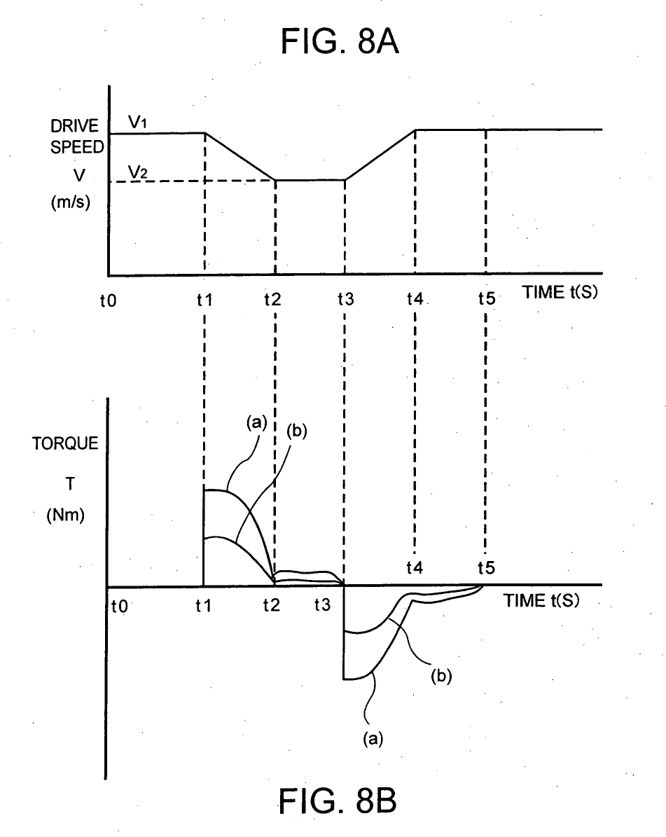

Next, the operation of the weight detection portion 50 of postal matter will be explained by referring to FIGS. 8A and 8B.

In FIG. 8A, timing t0 represents a moment the postal matter Y is clamped and taken in by the drive roller 51a and the pinch roller 51b and is sent at a drive speed of V₁ (first drive speed) in the direction of the arrow A drawn, and the front end of the conveyed postal matter reaches the position sensor 54.

In FIG. 8A, timing t1 represents a moment the postal matter Y reaches the position sensor 54 and then the front end of the postal matter Y conveyed at a constant speed reaches the nip of the drive roller 52a and the pinch roller 52b.

In FIG. 8A, timing t2 represents a moment the front end of the postal matter Y reaches the nip of the drive roller 52a and the pinch roller 52b, then is decelerated by the drive roller 52a and the pinch roller 52b, and reaches the position sensor 55. Between the timing t1 and the timing t2, until the drive speed V₁ (first drive speed) is decreased gradually to the drive speed V₂ (second drive speed), the drive speed is controlled by the torque control circuit 44. Namely, the control circuit 44, so as to decrease almost linearly the drive speed from V1 to V2 between the timing t1 and the timing t2, sets the number of rotations of the servo motor 11 several times every predetermined time.

Next, the operation of the torque T between the timings t1 and t2 will be explained. The torque T can be obtained from a variation of dE of kinetic energy E1 when the drive speed is decreased from V1 to V2.

Namely, the kinetic energy E1 received by the postal matter Y decelerated when it is clamped by the drive roller 51a and the pinch roller 51b and is conveyed in the direction of the arrow A drawn is given by Equation (9) by using a weight of m of the postal matter Y when the drive speed is V₁.
E1=(½)mV₁²(J) (9)

Further, the drive speed is decelerated from V₁ (initial speed) to V₂, so that the variation dE of the kinetic energy E1 in this case is given by Equation (10).
dE=(½)m(V₁−V₂)²(J) (10)

The variation dE of the kinetic energy given by Equation (10) is added to the drive roller 52a and the pinch roller 52b and the torque T in proportion to the kinetic energy dE can be obtained. Therefore, the torque T at this time is given by Equation (11).
T=K₁.dE(N.m) (11)
T=K₁.(½)m(V₁−V₂)²(N.m) (12)
where K₁ is a conversion coefficient when the kinetic energy is converted to torque.

Next, the relationship between the weight of postal matter and the torque T will be explained. The torque T given by Equation (12) is changed as shown by the curve (a) in the graph shown in FIG. 8B where the axis of abscissa represents the time t and the axis of ordinate represents the torque T (V1>V2). Further, from Equation (12), the weight m of the postal matter Y can be expressed using Equation (13).
m=K₂.2T/(V₁−V₂)²(K) (13)
where K₂ is a conversion coefficient for calculating the weight from the torque T.

Equation (13) represents that when the weight m of the postal matter Y is, for example, a half of the ordinary weight of (½)m, the torque T becomes (½)m. In the aforementioned relationship, for example, the torque characteristic in the case of the weight m is represented by the curve (a) shown in FIG. 8B and the torque characteristic in the case of the weight (½) m is represented by the curve (b) shown in FIG. 8B. The weight of the postal matter Y is measured in this way.

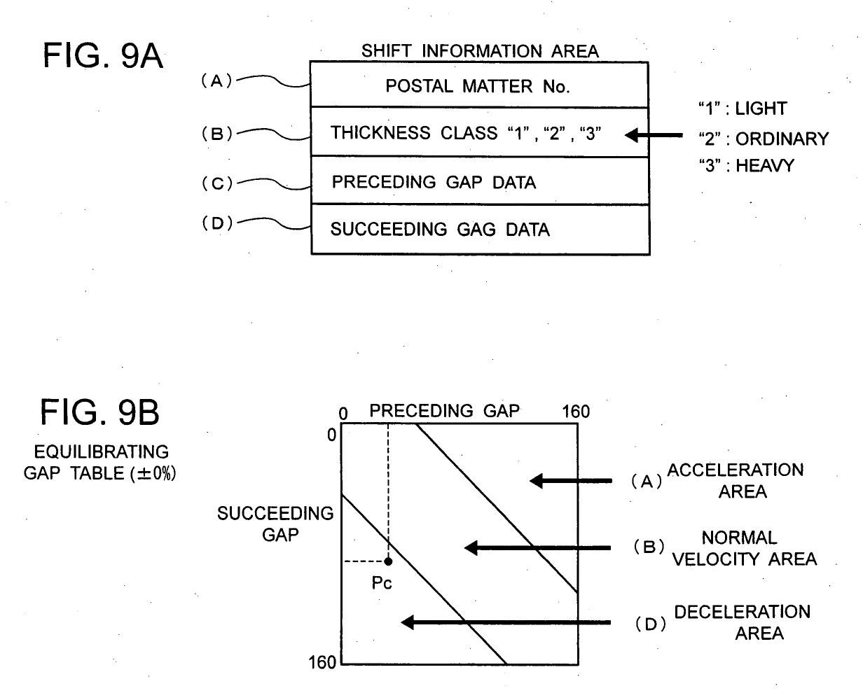

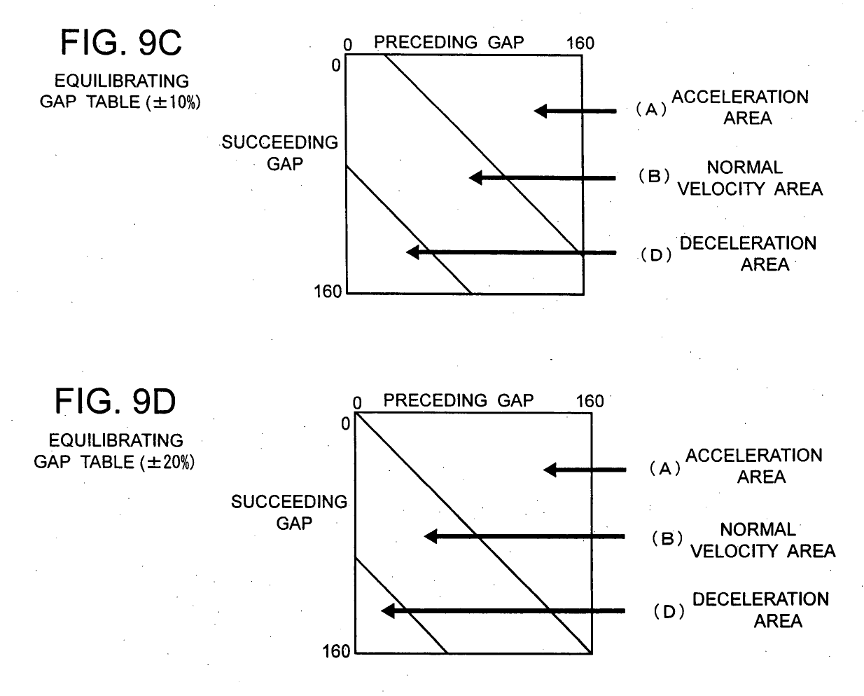

FIG. 9 shows the shift information area and the gap table, which are stored in the memory 37a, for correcting a gap on the basis of the weight class of postal matter. The gap table is a table of a correction value for correcting the gap between conveyed postal matters and is stored in the memory 37a. Hereinafter, a setting means for setting the drive speed of the variable speed driving means 42 will be explained by using a correction value stored in the memory 37a. Further, in the variable speed driving means 42, a correction value is set by a CPU (not drawn) of the gap correction controller 37.

FIG. 9A shows a shift information area set for each postal matter to sort the postal matter to be conveyed. In FIG. 9A, an area A shows a zip code equivalent to the ID of postal matter. In FIG. 9A, an area B shows weight class of postal matter and on the basis of the weight of postal matter which is detected by the weight sensor, weight class “1” of postal matter, weight class “2” of postal matter, and thickness class “3” of postal matter are set as shown by the following Equations (4) to (6).
“1”: postal matter weight≦0 (4)
“2”: 0<postal matter weight≦P (5)
“3”: P<postal matter weight≦Q (6)

In FIG. 9A, an area C shows the gap data between the concerned postal matter measured by the gap measuring sensor 47 and the postal matter conveyed previously. In FIG. 9A, an area D shows succeeding gap information, that is, the data of the gap between the present postal matter to be corrected which is measured by the gap measuring sensor 47 and the just after succeeding postal matter, that is, the succeeding gap.

FIGS. 9B to 9D show the gap tables. The gap tables, on the basis of the weight class (“1”, “2”, and “3” represented above) of postal matter which is set in the shift information area, are used to set a drive speed of the variable speed driving means 42 according to data set by preceding gap information and succeeding gap information. This embodiment can be explained by replacing “postal matter thickness” in Embodiment 1 shown in FIGS. 4A to 4D with “postal matter weight”. Namely, a case of thin postal matter is equivalent to a case of light postal matter and similarly a case of thick postal matter is equivalent to a case of heavy postal matter.

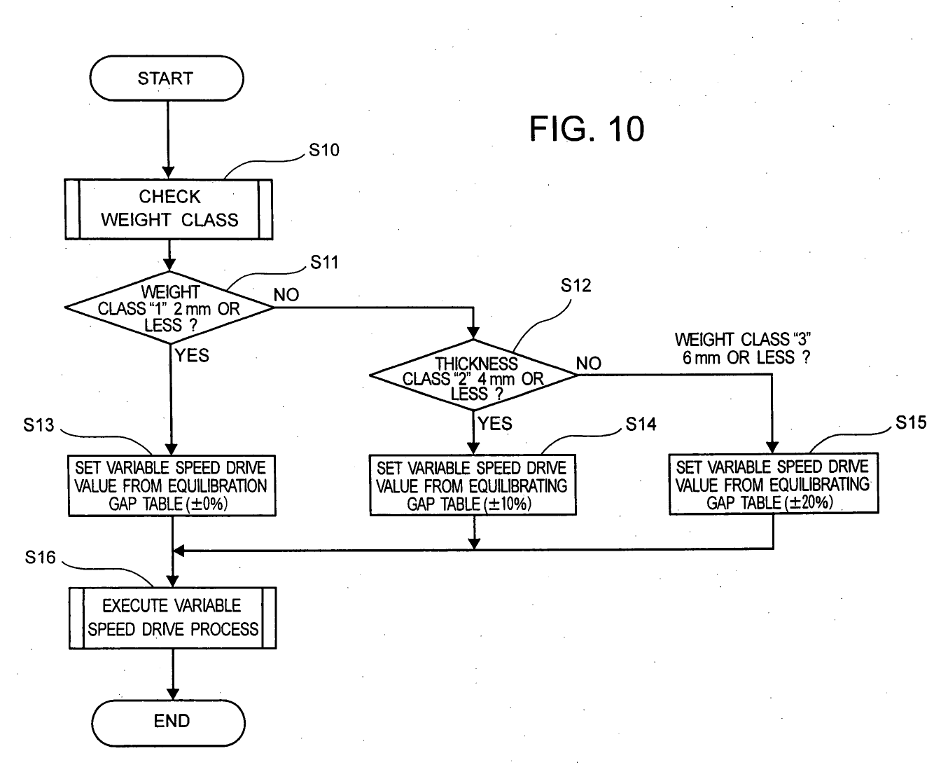

FIG. 10 is a flow chart showing the flow of the gap correction process based on the weight class of postal matter. Firstly, the weight class of postal matter is checked (Step S10).

As a result of the weight class check, when the weight of postal matter is up 0 (weight class is “1”) (branch of yes at Step S11), the process goes to Step S13 and sets one drive speed from the equilibrating gap table (±0%) information.

As a result of the weight class check, when the weight of postal matter is above 0 up to P (weight class is “2”) (branch of yes at Step S12), the process goes to Step S14 and sets one drive speed from the equilibrating gap table (±10%) information.

As a result of the weight class check, when the weight of postal matter is above P up to Q (weight class is “3”) (branch of no at Step S12), the process goes to Step S15 and sets one drive speed from the equilibrating gap table (±20%) information.

On the basis of one drive speed selected from the equilibrating gap table (Steps S13 to S15), the gap correction process is executed. By doing this, a gap correction operation added with the conveyance delay caused by the weight of postal matter can be realized.

### Embodiment 3

FIGS. 11A to 11C are drawings showing the shift information area and the gap table, which are stored in the memory 37a, for correcting a gap on the basis of gap information between conveyed postal matter at two separated places on the conveying path. The gap tables show shift information composed of preceding gap information and succeeding gap information at the two places aforementioned. Namely, in Embodiments 1 and 2, each gap is corrected according to attributes of postal matter such as the thickness and the weight of postal matter, though the preceding gap and the succeeding gap may become unequal depending on the material of postal matter and this embodiment is applied to correct it.

FIG. 11A shows a shift information area set for each postal matter to sort the postal matter to be conveyed.

An area A shown in FIG. 11A shows a zip code equivalent to the ID of postal matter. An area B shown in FIG. 11A shows preceding gap information of postal matter measured at the entrance of the conveying path of the VCS process. An area C shown in FIG. 11A shows succeeding gap information of postal matter measured at the entrance of the conveying path of the VCS process. An area D shown in FIG. 11A shows preceding gap information of postal matter measured before the gap correction apparatus. An area E shown in FIG. 11A shows succeeding gap information of postal matter measured before the gap correction apparatus.

FIGS. 11B and 11C show the gap tables. The gap tables are used to set a drive speed of the variable speed driving means 42 according to the data set by the preceding gap information and the succeeding gap information at the two places aforementioned which are set in the shift information area.

FIG. 11B is a gap table when the preceding gap and the succeeding gap of postal matter measured at the entrance of the conveying path of the VCS process and the preceding gap and the succeeding gap of postal matter measured before the gap correction apparatus coincide with each other. Here, it is judged that even if the attributes (material, thickness, size, etc.) of postal matter are different, the grip force of postal matter against the belt is the same and the postal matter is hardly delayed during conveyance, thus the equilibrating gap tables are combined so as to make the preceding gap and the succeeding gap equal.

FIG. 11C is a gap table when the preceding gap and the succeeding gap of postal matter measured at the entrance of the conveying path of the VCS process and the preceding gap and the succeeding gap of postal matter measured before the gap correction apparatus do not coincide with each other. Here, it is judged that even if the attributes (material, thickness, size, etc.) of postal matter are similar, the grip force of postal matter against the belt is different and the postal matter is easily delayed during conveyance, thus the gap tables are combined so as to correct the gap delay for the preceding gap and the succeeding gap. These gap tables are varied with a difference in the gap between two places.

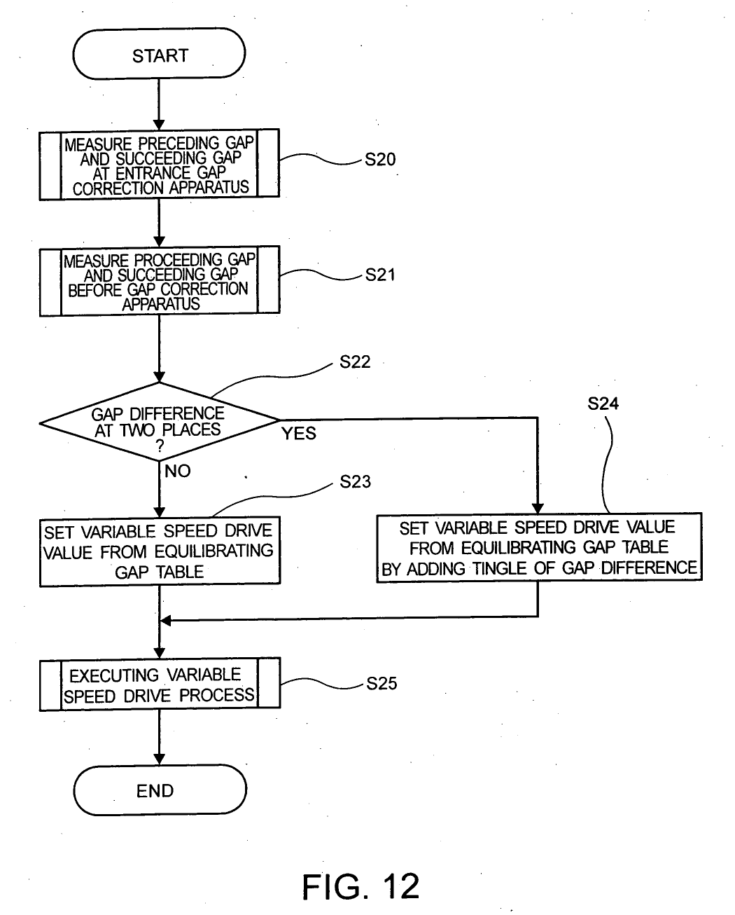

FIG. 12 is a flow chart showing the flow of the gap correction process based on the gaps between conveyed postal matter at the two places aforementioned. Firstly, the preceding gap and the succeeding gap of postal matter are measured by a sensor in the neighborhood of the entrance of the conveying path of the VCS process (Step S20).

Next, when the postal matter reaches the neighborhood of the gap correction apparatus, the preceding gap and the succeeding gap of postal matter are measured again by the sensor (Step S21).

Next, the preceding gap and the succeeding gap measured at the two places aforementioned are compared (Step S22) and when they are the same, the process goes to Step S23 and sets one drive speed from the equilibrating gap table information (ordinary correction). When they are different from each other, the process sets one drive speed from the equilibrating gap table information (excessive correction) by adding a tingle of the gap difference (Step S24).

On the basis of one drive speed selected from the equilibrating gap table (Steps S23 and S24), the gap correction process is executed. By doing this, the gap correction operation added with the conveyance delay caused by the attributes (material, thickness, size, etc.) of postal matter can be realized.

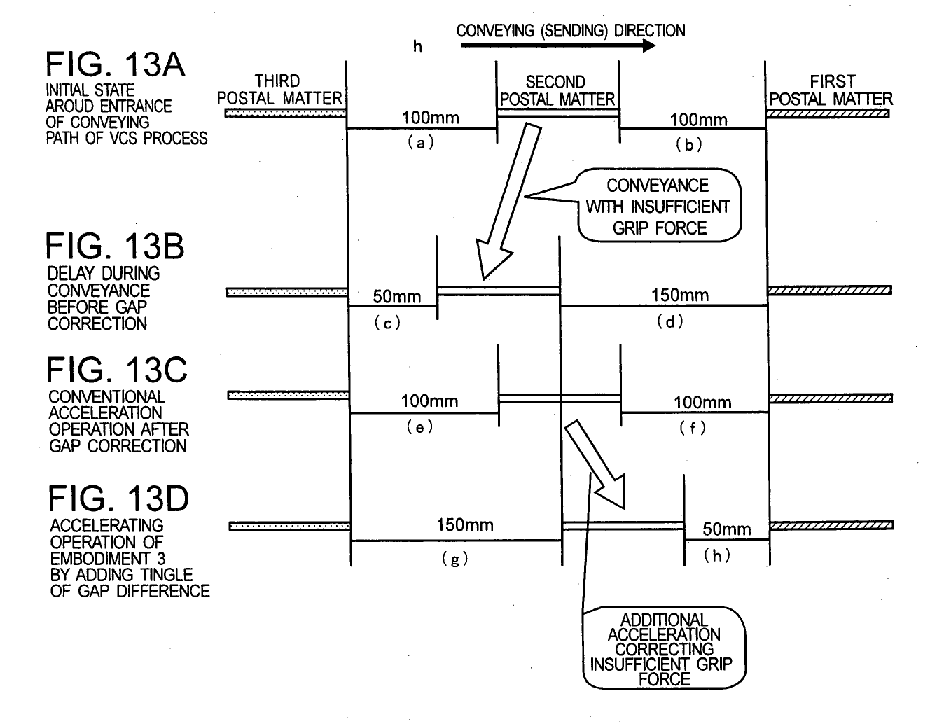

FIGS. 13A to 13D show an example when the gap correction is executed on the basis of the flow chart shown in FIG. 10. FIG. 13A shows the initial state of the gap between conveyed postal matter measured in the neighborhood of the entrance of the conveying path 6 of the VCS process. Here, sequentially from the top, the first and the third postal matters are postal matter with a thickness of 2 mm whose grip force is normal. The second postal matter is postal matter with a thickness of 2 mm whose grip force is weak. Among them, the second postal matter is driven at various speeds by the variable speed driving means 42, and a condition that the gaps between the second postal matter and the preceding and the succeeding postal matters, that is, the first and third postal matter is adjusted will be explained by referring to FIGS. 13B to 13D.

FIG. 13B shows a case that the second postal matter before gap correction which is measured before the gap correction apparatus 11 is delayed during conveyance. In this case, in the shift information area, the succeeding gap (a) measured at the entrance of the conveying path 6 of the VCS process is 100 mm, and the preceding gap (b) is 100 mm, and the succeeding gap (c) measured before the gap correction apparatus is 50 mm, and the preceding gap (d) is 150 mm. From the relationship of succeeding gap (a)>succeeding gap (c) and preceding gap (b)<preceding gap (d), it is found that the second postal matter is postal matter which is apt to be delayed during conveyance.

FIG. 13C shows a conveyance condition of postal matter after gap correction which is accelerated by the conventional method after gap correction. FIG. 13D shows a conveyance condition of postal matter after gap correction which is accelerated by the method of this embodiment. FIGS. 13C and 13D are shown by comparison to easily confirm a difference between the conveyance condition by the conventional method and the conveyance condition by this embodiment.

The conventional gap correction process executes so as to make the preceding gap and the succeeding gap equal, so that after gap correction, the succeeding gap (e) becomes 100 mm and the preceding gap (f) becomes 100 mm. However, in this method, it can be inferred that the concerned postal matter is easily delayed in conveyance, so that in this embodiment, the gap correction is executed by adding the tingle of the delay. Namely, in FIG. 13B, the succeeding gap (c) is easily delayed by about 50 mm in the subsequent conveying path, so that if the acceleration amount is increased so as to move it forward by +50 mm at time of acceleration, when the aforementioned conveyance delay is caused in the long subsequent conveying path up to stacking, the preceding gap and the succeeding gap of the postal matter are made just equal.

[Modifications]

The gap correction apparatus (the first gap correction apparatus) 11 in Embodiment 1, the gap correction apparatus (the second gap correction apparatus) 11 in Embodiment 2, and the gap correction apparatus (the third gap correction apparatus) 11 in Embodiment 3 can be equipped independently on the postal matter processing apparatus 100 to correct the gap between conveyed postal matter. However, when the postal matter processing apparatus 100 is large and the conveying path is long, these gap correction apparatuses are combined and equipped properly, thus a more preferable gap correction can be realized. For example, on the supply-reading apparatus 10 shown in FIG. 1, the first gap correction apparatus 11 based on detection results of the thickness detecting means is arranged and on the stacker 110 shown in FIG. 1, the third gap correction apparatus 11 based on the gap information between conveyed postal matter at two separated places in the conveying path is arranged. In this case, not only the gap between conveyed postal matter due to the thickness of postal matter is corrected by the first gap correction apparatus but also a displacement of the gap between conveyed postal matter, which is naturally caused when the conveying path is long, by the third gap correction apparatus arranged on the downstream side of the conveying path.

Further, in the embodiment aforementioned, the method for correcting the gap between conveyed postal matter is explained. However, the method is not limited to it and may correct the pitch between conveyed postal matter. In this case, for example, by an optical sensor similar to that of the embodiment aforementioned, the point of time when the front end of each postal matter supplied from the postal matter supplying means at a predetermined speed passes it is checked, thus the pitch between conveyed postal matter can be measured.

Additionally, the present invention is not limited only to the embodiments which are described above and shown in the drawings and can be modified and executed within a range which is not deviated from the objects of the present invention. For example, the thickness class and the weight class aforementioned are not limited to three classes and two or more appropriate classes may be applied.

According to the present invention, postal matter is classified by the thickness and the weight thereof or at least one of them and a difference in the gap between conveyed postal matter at two separated places on the conveying path and on the basis of this thickness class, a gap (a preceding gap) between the present postal matter to be corrected and the just prior preceding postal matter, and a gap (a subsequent gap) between the present postal matter to be corrected and the just after succeeding postal matter, the postal matter to be corrected is driven at variable speeds, thus a gap between postal matter is corrected.

As described above, the present invention can provide an extremely preferable an inter-conveyed postal matter gap correction apparatus for correcting an inter-conveyed postal matter gap of the postal matter to be conveyed and a postal matter processing apparatus equipped with the inter-conveyed postal matter gap correction apparatus.

While there have been illustrated and described what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

What is claimed is:

1. An inter-conveyed postal matter gap correction apparatus, comprising:
postal matter supply means for supplying postal matter;
conveying means for conveying said postal matter supplied from said postal matter supply means;
thickness detecting means for detecting a thickness of said postal matter conveyed by said conveying means;
a gap measuring sensor for measuring a gap between said postal matter conveyed by said conveying means;
variable speed driving means arranged on a downstream side of said thickness detecting means and said gap measuring sensor for increasing or decreasing a conveying speed of said postal matter;
a memory for storing a correction value for increasing or decreasing said conveying speed of said postal matter by said variable speed driving means on the basis of said thickness of said postal matter detected by said thickness detecting means, a preceding gap which is a gap between said present postal matter to be corrected measured by said gap measuring sensor and a just prior preceding postal matter, and a succeeding gap which is a gap between said present postal matter to be corrected and a just after succeeding postal matter; and
setting means for setting a drive speed of said variable speed driving means using said correction value stored in said memory.

2. An inter-conveyed postal matter gap correction apparatus according to claim 1, wherein said thickness detecting means includes:
classifying means for classifying said thickness of said detected postal matter into three classes of, in ascending order of thickness, thickness class “1” to thickness class “3”;
selecting means for selecting one kind from said correction values classified into three classes according to said three classes of classifying by said classifying means on the basis of said thickness class of said postal matter; and
correction value selecting means for selecting said correction value from said correction values of said selected kind by said selecting means on the basis of said preceding gap and said succeeding gap.

3. An inter-conveyed postal matter gap correction apparatus comprising:
postal matter supply means for supplying postal matter;
conveying means for conveying said postal matter supplied from said postal matter supply means;
weight detecting means for detecting a weight of said postal matter conveyed by said conveying means;
a gap measuring sensor for measuring a gap between said postal matter conveyed by said conveying means;
variable speed driving means arranged on a downstream side of said weight detecting means and said gap measuring sensor for increasing or decreasing a conveying speed of said postal matter;
a memory for storing a correction value for increasing or decreasing said conveying speed of said postal matter by said variable speed driving means on the basis of said weight of said postal matter detected by said weight detecting means, a preceding gap which is a gap between said present postal matter to be corrected measured by said gap measuring sensor and a just prior preceding postal matter, and a succeeding gap which is a gap between said present postal matter to be corrected and a just after succeeding postal matter; and
setting means for setting a drive speed of said variable speed driving means using said correction value stored in said memory.

4. An inter-conveyed postal matter gap correction apparatus according to claim 3, wherein said weight detecting means includes:
classifying means for classifying said weight of said detected postal matter into three classes of, in ascending order of weight, weight class “1” to weight class “3”; and
said setting means includes:
selecting means for selecting one kind from said correction values classified into three classes according to said three classes of classifying by said classifying means on the basis of said weight class of said postal matter; and
correction value selecting means for selecting said correction value from said correction values of said selected kind by said selecting means on the basis of said preceding gap and said succeeding gap.

5. An inter-conveyed postal matter gap correction apparatus according to claim 1 or 3, further comprising a gap correction apparatus for correcting said gap between said postal matter on the basis of said gap measuring sensor for measuring said gap between said postal matter at two separated places on a conveying path.
